(19) United States
(12) Patent Application Publication
(10) Pub. No.: US 2013/0241937 A1
(43) Pub. Date: Sep. 19, 2013

(54) Social Interaction Analysis and Display

(71) Applicants: Lisa Seacat DeLuca, San Francisco, CA (US); Lydia M. Do, Raleigh, NC (US)

(72) Inventors: Lisa Seacat DeLuca, San Francisco, CA (US); Lydia M. Do, Raleigh, NC (US)

(73) Assignee: INTERNATIONAL BUSINESS MACHINES CORPORATION, Armonk, NY (US)

(21) Appl. No.: 13/418,793

(22) Filed: Mar. 13, 2012

(51) Int. Cl. G06T 1/00

(52) U.S. Cl. 345/501

(57) ABSTRACT

Provided are techniques for storing information for identifying and characterizing a plurality of user characterizations associated with a social networking application; parsing a display associated with the social networking application to identify a first user characterization of the plurality of user characterizations; correlating the first user characterization to a first portion of the stored information; analyzing the first portion with respect to a first user-defined criteria; and in response to a determination that the first portion satisfies the first user-defined criteria, displaying, on the display, first data corresponding to the first portion in conjunction with a first indicia to enable the first data to be associated with the first user characterization.

### FIELD OF DISCLOSURE

The claimed subject matter relates generally to social networking applications and, more specifically, to techniques for saving and displaying information corresponding to selected elements within a social networking application.

### SUMMARY

The advent of the Internet during the 1990's opened up new avenues of communication among computer users around the world. Both personal users and businesses established identities on the Internet for both recreation and commercial reasons. During the past two decades, traffic on the Internet has increased exponentially and available context has expanded into many different areas, including social networking applications. Two such contexts are social networking services such as Facebook, provided by Facebook, Inc., and Twitter, provided by Twitter, Inc. of San Francisco, Calif., and virtual worlds (“VWs”) such as Second Life (“SL”), supported by Linden Research, Inc., or “Linden Labs,” of San Francisco, Calif. as well as Entropia Universe, Sims Online, There, Red Light Center as well as massively multiplayer games such as EverQuest, Ultima Online, Lineage and World of Warcraft.

Social networking services such as Facebook and Twitter should be familiar to those with experience in the computing arts and, basically, a VW is an Internet-based simulated environment in which users interact via “avatars,” or computer representations of a user. Often a VW resembles the real world with respect to such things as physics and object, e.g. houses and landscapes. Other terms associated with VWs are a “metaverse,” which is a collection of VWs, and “3D Internet.” VW users are presented with perceptual stimuli and typically are able to both manipulate elements of the VW and communicate with other users via the avatars. The following definitions explain a few of the basic concepts of a VW:
Avatar: VW user's representation of him or herself in the VW that other users can see, often taking the form of a cartoon-like human.
Agent: particular user's account, upon which the user can build an avatar and which is tied to an inventory of assets owned by the user.
Region: virtual area of land within a VW, typically residing upon a single computer server.

Assets, avatars, the VW environment and anything visual within a VW is associated with a unique identifier (UUID) tied to geometric data, which is distributed to users as textual coordinates, textures, which are distributed as graphics files, and effects data, which are rendered by a user's client process according to the user's preferences and the user's device capabilities.

Provided are techniques for storing information for identifying and characterizing a plurality of user characterizations associated with a social networking application; parsing a display associated with the social networking application to identify a first user characterization of the plurality of user characterization; correlating the first user characterization to a first portion of the stored information; analyzing the first portion with respect to a first user-defined criteria; and in response to a determination that the first portion satisfies the first user-defined criteria, displaying, on the display, first data corresponding to the first portion in conjunction with a first indicia to enable the first data to be associated with the first user characterization.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures, in which:

FIG. 1 is a block diagram of a computing system architecture that may implement the techniques of the disclosed subject matter.

FIG. 2 is an illustration of a display of a virtual world on the client system of FIG. 1 showing a user characterization, in this example an avatar, various setting elements and a pop-up menu that implements aspects of the claimed subject matter.

FIG. 3 is an illustration of the display of FIG. 2 showing a different scene in the virtual world of FIG. 2 and a number of avatars, including the avatar introduced in FIG. 1.

FIG. 4 is a block diagram of a Social Networking Element Capture Module (SNECM), first introduced in conjunction with FIG. 1, in greater detail.

FIG. 5 is a flowchart of one example of an Operate SNECM process that may implement aspects of the claimed subject matter.

FIG. 6 is a flowchart of one example of a Gather Data process that may implement aspects of the claimed subject matter.

FIG. 7 is a flowchart of one example of an Analyze Display process that may implement aspects of the claimed subject matter.

FIG. 8 is an illustration of the display of FIGS. 2 and 3 showing an example of a view in a social networking application that implements the claimed subject matter.

### DETAILED DESCRIPTION

Although described with particular reference to a virtual world (“VW”) and the interaction of avatars, the claimed subject matter can be implemented in any social networking application in which users are interacting through user characterizations such as, but not limited to, profiles, postings and avatars. Those with skill in the computing arts will recognize that the disclosed embodiments have relevance to a wide variety of computing environments in addition to those used as examples below.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As the Inventors herein have realized, the world is a busy place with many people interacting online via VW applications, social applications and so on. As a result, people are bombarded with information. Therefore, there is a need for tools/analytics to help in dynamically engaging with people online. One example of such a tools/analytics would be techniques to help recall pertinent information about other people encountered within interactions. Another example would be tool/analytics to prioritize interactions and potential interactions.

In addition, virtual realities such as a computer game do not provide any mechanism for a user to remember, i.e. save and recall, any detail of a particular setting other than by means of a screen shot. Unfortunately, a screen shot only preserves the look of the particular setting and not any detailed information about elements represented in the setting. For example, if a user would like to save for later recall information about another user's avatar within the setting, the user typically would manually write down the information, which is not an effective technique for managing virtual world or gaming contacts.

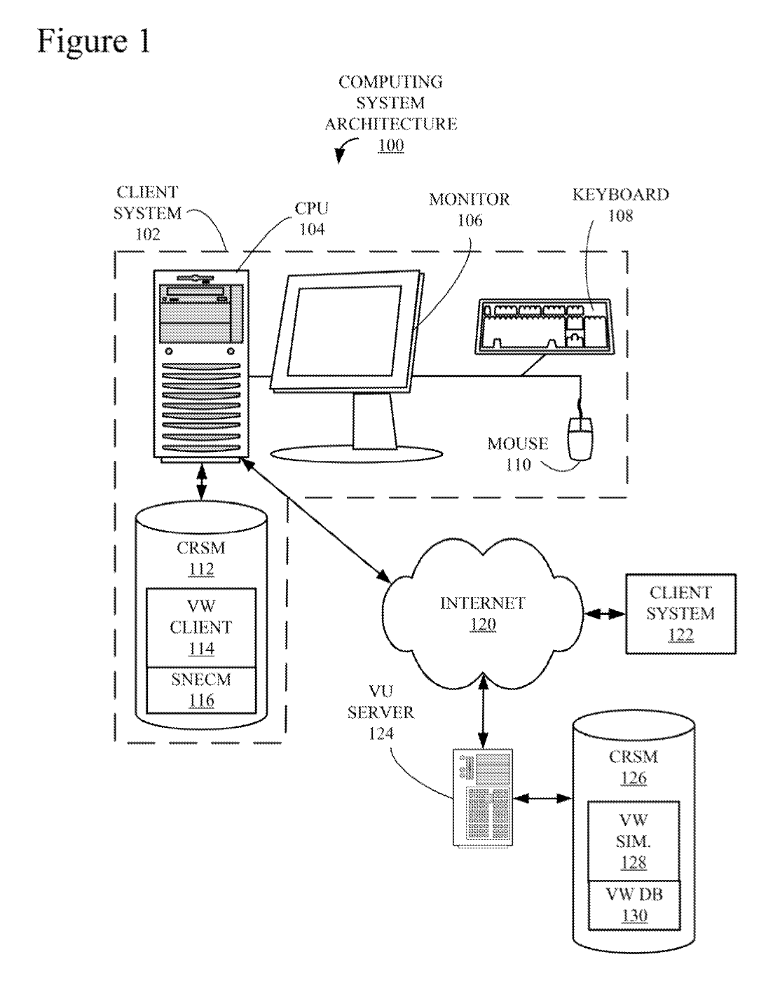

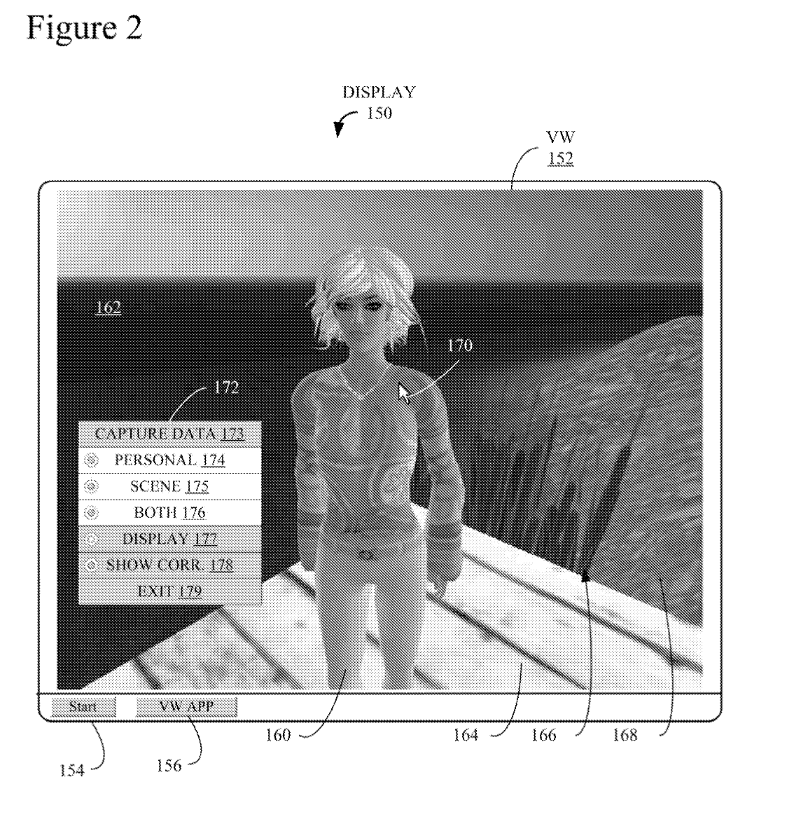

Turning now to the figures, FIG. 1 is a block diagram of one example of a computing system architecture 100 that may incorporate the claimed subject matter. A client system 102 includes a central processing unit (CPU) 104, coupled to a monitor 106, a keyboard 108 and a pointing device, or “mouse,” 110, which together facilitate human interaction with computing system architecture 100 and client system 102. Also included in client system 102 and attached to CPU 104 is a computer-readable storage medium (CRSM) 112, which may either be incorporated into CPU 104 i.e. an internal device, or attached externally to CPU 104 by means of various, commonly available connection devices such as but not limited to, a universal serial bus (USB) port (not shown). CRSM 112 is illustrated storing an example of a virtual world (VW) client 114. VW client executes on CPU 104 to display and enable interaction with a virtual world 152 (see FIG. 2). Coupled to VW client 114 is a Social Networking Element Capture Module (SNECM) 116. The function of VW client 114 and SNECM 118 are is described in detail below in conjunction with FIGS. 2-8. As mentioned above, the disclosed technology is equally applicable in settings other than virtual worlds such as, but not limited to, any current or future social and business networking applications and services. The term “Virtual World” in conjunction with various elements described throughout this Specification is used merely within the context of the following examples. Further, it should be understood that the claimed subject matter is not limited to functioning in one type of social networking application at a time. For example, an implementation in a VW may retrieve, analyze and display information from a social networking server and vice versa.

Client system 102 is coupled to the Internet 120, which is also connected to a second client system 122 and a VW server, or simply a “server,” 124. Computing system 122 and server 124 would typically include many of the same components as client system 102, including a CPU, a monitor, a keyboard and a mouse. Like client system 102, in the following examples, client system 122 would also include a VW client such as VW client 114. These additional components of client system 122 and server 124 should be familiar to one with skill in the relevant arts and, for the sale of simplicity, are not illustrated.

Server 124 is coupled to a CRSM 126. Server 124 functions as a VW server, i.e. it is responsible for transmitting data corresponding to particular areas, or “regions,” of VW 152 (see FIG. 2) to VW client 114 so that VW 152 can be instantiated on client system 102. VW 152 is instantiated by the execution of a VW simulator (sim.) 128, stored on CRSM 126. CRSM 126 also stores a VW database (DB) 130, which may be executing as a function of a database management system (DBMS) (not shown).

Although in this example, client systems 102 and 122 and server 124 are communicatively coupled via the Internet 120, they could also be coupled through any number of communication mediums such as, but not limited to, a local area network (LAN) (not shown). Further, it should be noted there are many possible computing system configurations, of which computing system architecture 100 is only one simple example. It should be noted that a typical VW architecture could involve dozens if not hundreds of servers and perhaps hundreds if not thousands of clients but for the sake of simplicity only one or two of each are shown.

FIG. 2 is an illustration of an example of a display 150 of a virtual world 152 that might be shown on monitor 106 (FIG. 1) of client system 102 (FIG. 1). Display 150 includes several elements for controlling display 150 that should be familiar to one with skill in the relevant arts, including a “Start” button 154 and a menu bar icon 156 corresponding to an application rendering VW 152.

VW 152 is illustrated with an avatar 160, a background, or region, 162 and various display objects 164, 166 and 168. In this example, VW 152 is displayed on monitor 106 for the benefit of a user of client system 102 by VW Client 114 (FIG. 1) under the control of VW Simulator 128 (FIG. 1). Avatar 160 represents a user, on client system 122 (FIG. 1) who is logged into VW 152. Typically, only a portion of region 162 is displayed at any point in time. Region 162 includes a platform 164 on which avatar 160 appears to be standing, object 166 represents plant life and object 168 represents land. Objects 164, 166 and 168 are examples of various items that may be added to a region such as region 162 to make the region appear more like the real world and give visual clues that distinguish one region from another.

Information necessary to display VW 152, avatar 160 and setting objects 164, 166 and 168 is stored in VW DB 130 (FIG. 1) of VW server 124 (FIG. 1). The control of avatar 160 is executed by the user in conjunction with a VW client 122 and VW server 124 and displayed on monitor 106 of client system 102 by VW client 114. Typically, different VW servers may be responsible for a particular region, or grid, of VU 152. In the following examples, the rendering of region 162 is the responsibility of a VW Sim. 128 executing on server 124.

Also displayed in FIG. 2 is a cursor 170 that, in this example is currently positioned over avatar 160, and a menu 172. Menu 172 is typically displayed when the user on client system 102 depresses, or “clicks,” a left button (not shown) on mouse 110, while cursor 170 is positioned over an object, which in this example is avatar 160. Menu includes a title, i.e. “Capture Data” 173, three (3) possible choices or “selections,” i.e. a “Personal” selection 174, a “Scene” selection 175, and a “Both” selection 176. Also illustrated are three (3) action buttons, i.e., a “Display” button 177, a “Show Correlation (Corr.)” button 178, and an “Exit” button 179 that, when selected, causes menu 172 to be removed from display 150.

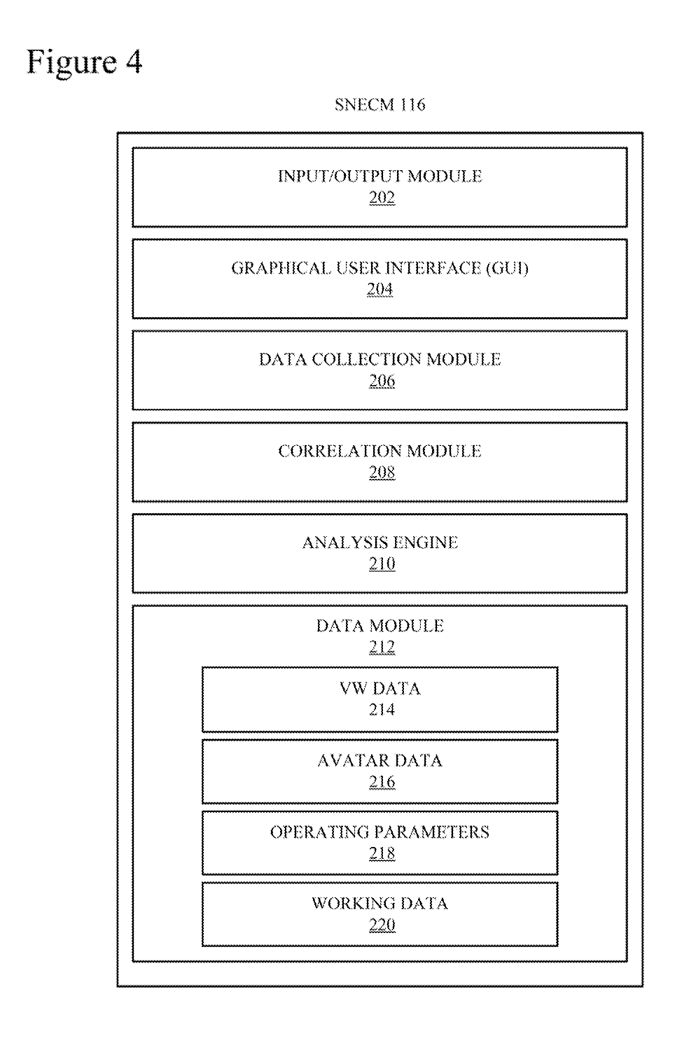

Capture Data 173 merely informs the user of the name of menu 172. Selections 174-176 enable the user to specify the particular type of information that is gathered when cursor 170 is positioned over a selection 174-176 and a right button (not shown) of mouse 110 is clicked. Information gathered relates to the object over which cursor 170 is positioned when menu 172 is displayed. In other words, Personal selection 175 gathers personal information relating to avatar 160 and potentially the user on client system 122 that corresponds to avatar 160. Such personal information may include, but is not limited to, contact information, such as but not limited to name and email address of the user on computing system 122. Scene selection 176 collects information on region 162, including but not limited to, a location within VW 152, information identifying scene 162, current objects 164, 166 and 168 and the current time and date. Both selection 176 gathers both personal and region information. Display 177 shows information stored about a corresponding avatar. Show Corr. 178 displays information relating to previous encounters with the selected avatar, including but not limited to, name, contact information, time and place. The specific information displayed is configurable (see 216, FIG. 4).

Rather than avatars, social and business networking applications other than VWs may represent users in different ways. For example, a user may be represented as a posted profile (e.g. Facebook) or simply by a tag appended to a comment (e.g. Twitter). Regardless, the disclosed technology enables a user to identify, collect information, analyze and display information on other users and their representations.

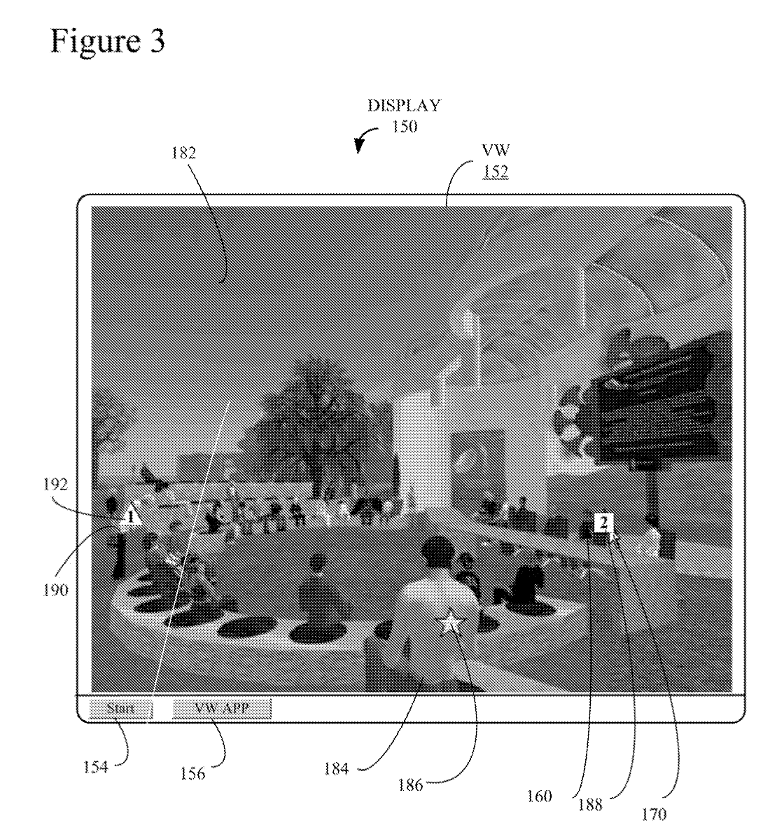

FIG. 3 is an illustration of display 150 (FIGS. 1 and 2) showing a second scene 182 in VW 152 (FIG. 2). In this example, scene 182 is presented on display 150 at a point in time after scene 162 of FIG. 1 and information related to avatar 160 (FIG. 2) has been previously captured and stored as explained above in conjunction with FIG. 2.

Scene 182 includes display objects (not labeled) and a number of avatars, including among others avatar 160, an avatar 184 and an avatar 190. In this example, a star 186 is positioned on avatar 184, a square 188 near avatar 160 and a triangle 192 near avatar 190. In this example, cursor 170 (FIG. 2) is positioned over triangle 188. Star 186, which is positioned over avatar 184, indicates that avatar 184 represents a user who is currently navigating scene 182, i.e. “U Prime” or “Up.”

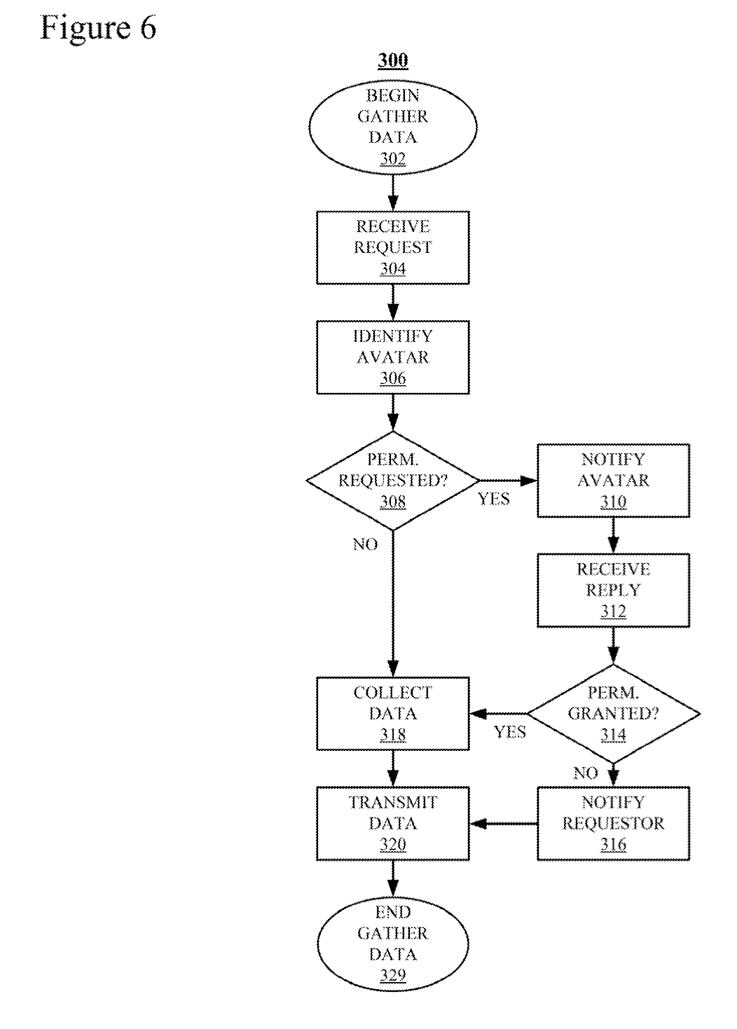

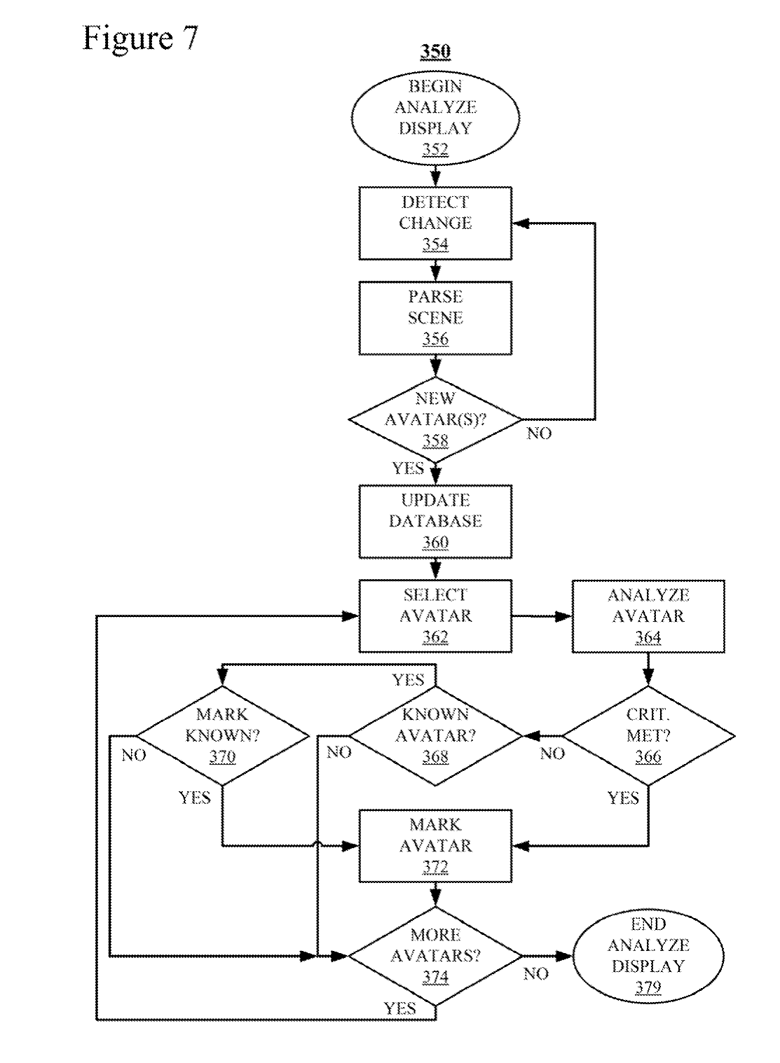

Triangle 192 positioned over avatar 190 indicates that the user associated with avatar 190 has been identified by an analysis engine 210 (see FIG. 4) as satisfying a set of user-defined rules and criteria. For example, the user associated with avatar 184 may specify that any avatar corresponding to a user employed by Company Y be tagged. Square 188 positioned over avatar 160 also indicates that the user associated with avatar 160 has been identified by an analysis engine 210 as satisfying a second set of user-defined criteria. In this example, different shapes, i.e. triangles and squares, indicate that different sets of criteria have been met with respect to avatars 160 and 190. In addition, a number ‘1’ in triangle 192 and a number ‘2’ in square 188 indicate an order of contact suggested by analysis engine 210 based upon user-defined rules and criteria. An order of contact may, for example, be based upon the relative position of a user with respect to their employer, e.g. presidents receive the number ‘1’ and vice-presidents receive the number ‘2’. In this example, there may be multiple avatars designated with the same number. Other shapes (not shown) may merely indicate that data corresponding to a particular avatar has been previously captured and stored in accordance with the disclosed technology (see 300, FIG. 6). A lack of any shapes positioned over other avatars (not labeled) indicates that those particular avatars do not either meet any defined criteria or been designated as avatars of interest, although data may still have been gathered about them (see 350, FIG. 7). For example, depending upon the configuration, all avatars that populate a scene may have that fact that they were in the scene recorded so that the information is available in the event that one is designated as an avatar of interest at some point in the future. It should be noted that, the particular shapes may be designated be the setting of configuration parameters and, in the alternative; colors may be employed to designate particular information.

In the following examples, Up, corresponding to avatar 184, is using computing system 102 (FIG. 1) and a second user, corresponding to avatar 160, is using client system 122 (FIG. 1). In addition, Up and the second user will primarily be referenced throughout the Specification as avatars 184 and 160, respectively, although there is a distinction between an avatar, i.e. the computer representation of a user, and the corresponding user. Whenever the distinction is relevant, either the avatar or the corresponding user will be specified.

Although illustrated with indicia such as star 186, square 188 and triangle 192, which, in this example, represent the availability of corresponding information, other types of indicia may also be employed. For example, there may be a separate panel (not shown) that simply includes text in conjunction with means for correlating specific entries in the panel with particular avatars, postings or comments. In addition, information may be displayed whenever a cursor such as cursor 170 is either positioned over a particular representation of a user or positioned and coupled to some other action such as a click on a mouse. Further, display of information may be controlled by user-defined parameters. For example, a user may toggle information display on or off or select from a number of display options depending upon the circumstances.

FIG. 4 is a block diagram of SNECM 116, first introduced in conjunction with FIG. 1, in greater detail. SNECM 116 includes an input/output (I/O) module 202, a graphical user interface (GUI) 204, a data collection module 206, a correlation module 208, an analysis engine 210 and a data module 212. For the sake of the following examples, SNECM 116 is assumed to execute on client system 102 (FIG. 1) and stored in data storage 112 (FIG. 1). As explained above in conjunction with FIG. 3, the following examples will be described with respect to the user corresponding to avatar 184 (FIG. 3), on client system 102, and the user corresponding to avatar 188 (FIG. 3) on client system 122 (FIG. 1). It should be understood that the claimed subject matter can be implemented in many types of computing systems and data storage structures but, for the sake of simplicity, is described only in terms of client system 102, client system 122, server 124 (FIG. 1) and other elements of architecture 100 (FIG. 1). Further, the representation of SNECM 116 in FIG. 3 is a logical model. In other words, components 202, 204, 206, 208, 210 and 212 may be stored in the same or separates files and loaded and/or executed within computing system 102 and system 100 either as a single system or as separate processes interacting via any available inter process communication (IPC) techniques.

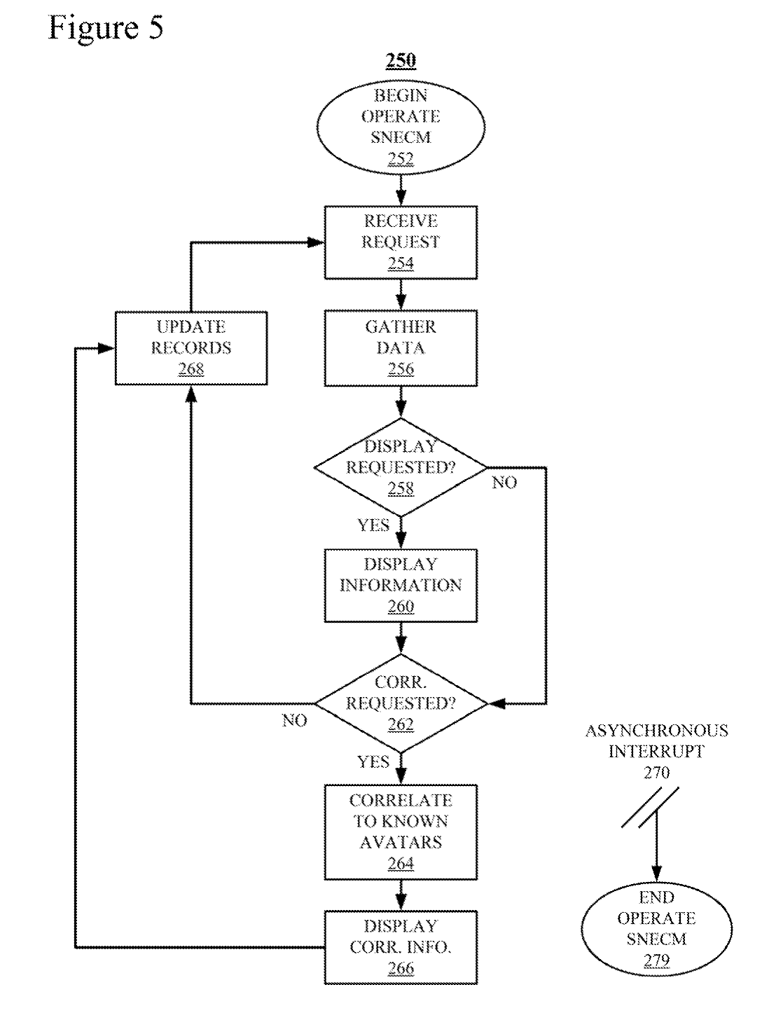

I/O module 202 contains logic to handle communication between SNECM 116 and other components of client system 102, server 124 and elements of architecture 100. GUI 204 enables users of SNECM 116 to interact with and to define the desired functionality of SNECM 116. For example, rules and criteria may be defined to specify particular avatars for identification and ordering (see 188 and 192, FIG. 3). Data collection module 208 contains logic to gather and store information about an avatar that has been selected. Such data may be gathered via a request for information to server 124 (see 256, FIGS. 5 and 300, FIG. 6).

Correlation module 208 contains logic to transform information relating to the position of cursor 170 (FIG. 2) and triangle 190 (FIG. 3) into information that identifies a particular avatar such as avatar 160 (FIG. 2) and avatar 188 (FIG. 3) and region, or portion of a region, such as region 162 (FIG. 2) and region 182 (FIG. 3). In addition, correlation module 208 correlates information about a current avatar with information about previously identified avatars. For example, a user may click on a particular avatar such as avatars 160 and 188 for information about whether or not the particular avatar has been previously identified and, if so, under what circumstances

Analysis engine 210 employs data stored in VW data 214 and avatar data 216 and data generated by data collection module 206 and correlation module 208 to provide additional information. Examples of such additional information may include, but is not limited to, other avatars to address, contact or speak to (perhaps in the event of multiple avatars within a particular setting), a suggested order of contact, context and avatar-specific greetings (e.g., “Last time we meet in April, you were getting married.”), lists of other avatars for introduction (“Bob, I'd like to introduce you to John. He has a background in industrial management.”) and information that may be used by GUI 204 to enhance the real-time experience of the user corresponding to avatar 184. In addition, analysis engine 210 is employed to parse and analyze scenes such as scenes 162 (FIG. 2) and 182 (FIG. 3).

In addition to any data collected as described above, data input into analysis engine 210 may include such data as a history of interaction (e.g., the number of times and the circumstances of previous interactions with a particular avatar), information entered by a user during a current or previous interaction (e.g., a “quality” or “importance” rating or data relating to a particular known fact), a user's status (e.g., a title, ranking and association), a relationship (e.g., business colleague or wife of a friend), notable exchanges and other avatars within a defined range of the user (e.g., the same conference room or same island). Within a social or business networking service, data may include such information relating to levels or circles of friends and/or associates.

Data module 212 is a data repository for information that SNECM 116 requires during normal operation. Examples of the types of information stored in data module 212 include a VW data 214, avatar data 216, operating parameters 218 and working data 220. VW data 214 stores information about the particular VW such as VW 152, currently on display.

Avatar data 216 stores information about avatars for which data has previously been encountered and/or captured. Examples of data are described above in conjunction with analysis engine 210. Among other things, avatar data 216 is employed by correlation module 208 to match data on a currently selected avatar to previously selected avatars and by analysis engine 210 for processing. In this example, information stored in avatar data 216 includes, but is not limited to, a history of interactions between avatar 188 and previously encountered avatars, quality ratings with a granularity of favorability with respect to past interactions, ranking, title and associations of users associated with avatars, relationships among avatars, notable exchanges, events corresponding to an avatar and proximity to other avatars, hobbies, interests and education. For example, information about a particular avatar may include that a corresponding user was encountered within specific meeting or region, was rated highly as a potential contact, is president of Company X, is friends with the president of Company Y, was recently married and maintains a certain level or circle of friends within a particular social networking application or service. Additional information may include noted added about a particular avatar or user associated with the avatar.

Operating parameters 218 includes information on various user preferences that have been set for controlling the operation of SNECM 116. For example, a user may specify the particular personal and scene information that is gathered for selected avatars.

Working data 220 stores data currently in use by logic associated with SNECM 116, including but not limited to, the intermediate results within ongoing processing. Components 202, 204, 206, 208, 210, 212, 214, 216, 218 and 220 are described in more detail below in conjunction with FIGS. 5-8.

FIG. 5 is a flowchart of one example of an Operate SNECM process 250 that may implement aspects of the claimed subject matter. In this example, logic associated with process 250 is stored in conjunction with SNECM 116 (FIGS. 1 and 4) of VW client 114 (FIG. 1) on CRSM 112 (FIG. 1) and executed on one or more processors (not shown) of CPU 104 (FIG. 1) of client system 102 (FIG. 1).

Process 250 starts in a “Begin Operate SNECM” block 252 and proceeds immediately to a “Receive Request” block 254. During processing associated with block 254, a request for avatar information is received in response to user input via I/O module 202 (FIG. 4) and GUI 204 (FIG. 4). In this example, avatar 184 has positioned cursor 170 (FIGS. 2 and 3) over triangle 188 (FIG. 3) and “clicked on” mouse 110 (FIG. 1) to indicate that information on avatar 160 (FIG. 3) is requested. The specific information requested, and ultimately displayed, may be specified by a user corresponding to the requesting avatar 184 (see 172-179, FIG. 2), configurable (see 218, FIG. 4) or any combination of the two. The information is generated by analysis engine 210 (FIG. 4) of SNECM 116 (FIGS. 1 and 4) based upon data stored in data module 212 (FIG. 4). In the alternative, the technology may be configured to display information on avatar 160 by merely positioning cursor 170 over triangle 190. In addition, a user may submit a request for information on all avatars within a particular scene or those avatars within a particular, designated area within a scene. In other words, although described for the sake of simplicity on a request for information corresponding to a single avatar, the disclosed technology is equally applicable to a requests and retrievals of information on identified groups of avatars.

During processing associated with a “Gather Data” block 256, Once the avatar or avatars that are the subject of the request are identified, information is gathered internally, from SNECM 116 (see 206, FIG. 4) and via a request for information transmitted to VW server 124 (see 300, FIG. 6). Additional information may be gathered from external sources such as, but not limited to, social networking services. During processing associated with a “Display Requested?” block 258, a determination is made as to whether or not the request received during processing associated with block 254 includes a request to display the information. If so, control proceeds to a “Display Information” block 260. During processing associated with block 260, the information gathered during processing associated with block 256 is displayed on monitor 106 (FIG. 1) to the requesting user. Once the information has been displayed during processing associated with block 260 or, if during processing associated with block 258, a determination is made that display has not been requested, i.e. the information is being collected and stored for future reference, control proceeds to a “Correlation (Corr.) Requested?” block 262.

During processing associated with block 262, a determination is made as to whether or not the request received during processing associated with block 254 includes a request to correlate the information to known avatars. If so, control proceeds to a “Correlate to Known Avatars” block 264. During processing associated with block 264, information is generated by analysis engine 210 (FIG. 4) relating to the identified avatar and corresponding relationships. During processing associated with a “Display Corr. Info” block 266, the information generated during processing associated with block 264 is displayed on monitor 106.

Following the display of correlation information, of, if during processing associated with block 262 that a correlation is not requested, control proceeds to an “Update Records” block 268. During processing associated with block 268, information gathered during processing associated with block 256 and, if applicable, information generated during processing associated with block 264 is stored in avatar data 216 for future reference. Control then returns to block 254 and processing continues as describe above.

During normal operation, process 250 loops through blocks 254, 256, 258, 260, 262, 264, 266 and 268 processing requests as they are received. Finally, in the event that VW client 114, SNECM 116 or client system 102 is halted, an asynchronous interrupt 270 is generated and control proceeds to an “End Operate SNECM” block 279 in which process 250 is complete.

FIG. 6 is a flowchart of one example of a Gather Data process 300 that may implement aspects of the claimed subject matter. In this example, logic associated with process 300 is stored in conjunction with VW Sim. 128 (FIG. 1) on CRSM 126 (FIG. 1) and executed on one or more processors (not shown) of a CPU (not shown) of VW server 124 (FIG. 1).

Process 300 starts in a “Begin Gather Data” block 302 and proceeds immediately to a “Receive Request” block 304. During processing associated with block 304, a request for information on one or more avatars is received by VM Sim. 128 (see 256, FIG. 5). In the following example, the received request corresponds to a single avatar although, as explained above, some requests may be associated with multiple avatars. During processing associated with an “Identify Avatar” block 306, the avatar specified in the request received during processing associated with block 304 is identified, i.e. associated with data stored in VW DB 130 (FIG. 1) corresponding to a particular, known avatar.

Configuration data associated with avatars may include information concerning the amount and type of data that the corresponding user is willing to be share with over avatars. During processing associated with a “Permission (Perm.) Requested?” block 308, a determination is made as to whether or not the particular avatar is configured to either refuse request for information or to check with the corresponding user for authorization to release data. If permission is necessary, control proceeds to a “Notify Avatar” block 310 during which the user corresponding to the avatar is notified of the request for information. During processing associated with a “Receive Reply” block 312, process 300 waits for a response to the query transmitted during processing associated with block 310. In addition, a timer (not shown) may be set such that expiration of the timer defaults to either permissions granted or not granted depending upon the current configuration. During processing associated with a “Perm. Granted?” block 314, a determination is made as to whether or not permission to release data has been received. Such permission may limit the type and amount of information such as specifying that only business contact and not personal contact information be released. In one embodiment, a user may be provided with a GUI (not shown) to check off specific information and/or types of information that may be either released or withheld.

If permission is not received, either explicitly or inexplicitly, control proceeds to a “Notify Requestor” block 316. During processing associated with block 316, the user who initiated the request for information is notified that no information is available. If, during processing associated with block 314, a determination is made that at least some information may be released, control proceeds to a “Collect Data” block 318 during which the authorized information is retrieved from VW DB 130 and formatted for transmission. In addition to information about the avatar, information about the current setting or scene may be sent, even if no avatar information is authorized for release. During processing associated with a “Transmit Data” block 320, setting information and avatar information, if authorized, is transmitted to the requesting user. Finally, during processing associated with an “End Gather Data” block 329, process 300 is complete.

FIG. 7 is a flowchart or one example of an Analyze Display process 350 that may implement aspects of the claimed subject matter. In this example, logic associated with process 350 is stored in conjunction with analysis engine 210 (FIG. 4) of SNECM 116 (FIGS. 1 and 4) of VW client 114 (FIG. 1) on CRSM 112 (FIG. 1) and executed on one or more processors (not shown) of CPU 104 (FIG. 1) of client system 102 (FIG. 1).

Process 350 starts in a “Begin Analyze Display” block 352 and proceeds immediately to a “Detect Change” block 354. During processing associated with block 354, a change in a scene, in this example scene 182 (FIG. 3), is detected. A change in scene may include, but is not limited to, avatar 184 navigating to an entirely different scene or a different perspective within a scene or the entry of one or more avatars that were not previously present in the scene. In addition, a change may include a modification to user-defined rules, criteria and/or parameters. In that case, each avatar in a particular scene would be reanalyzed, i.e. treated as a new avatar. During processing associate with a “Parse Scene” block 356, scene 192 is parsed to determine individual displayed elements such as, for example, avatars 160 and 190.

During processing associate with a “New Avatar(s)?” block 358, a determination is made as to whether or not and additional displayed elements identified during processing associate with block 356 represent one or more avatars the were not previously in the scene. Of course, if avatar 184 has navigated to an entirely new scene, then each avatar is typically new to the scene. If a new avatar is not detected, control returns to block 354 and processing continues as described above.

If, during processing associate with block 358, one or more new avatars are detected, control proceeds to an “Update Database” block 360. During processing associate with block 360, records are entered in avatar data 216 (FIG. 4) to indicate the presence of new avatars identified during processing associate with block 358. It should be noted that although each identified avatar may not be of interest, a record of an interaction may be relevant to avatar 184 in the future, when, for example, such an avatar is first designated as an avatar of interest.

During processing associate with a “Select Avatar” block 362, an avatar identified during processing associate with block 358 is selected for processing. During processing associate with an “Analyze Avatar” block 364, the avatar selected during processing associate with block 362, is correlated with records of avatars stored in avatar data 216 (see 208, FIG. 4) and evaluated based upon user-defined rules and criteria. For example, one rule may specify that all avatars corresponding to presidents of a company or associated with a specific company be identified. During processing associated with a “Criteria (Crit.) Met?” block 366, a determination is made as to whether or not the selected avatar meets any user defined criteria.

If not, during processing associate with a “Know Avatar?” block 368 a determination is made as to whether or not the selected avatar is a known avatar, i.e. corresponds to records in avatar data 216. If so, during processing associated with a “Mark Known?” block 370, a determination is made as to whether or not, based upon a user-defined parameter, VWECM 116 is configured to indicate all previously identified avatars. Once a determination has been made during processing associated with block 366 that the selected avatar meets user-defined criteria or, during processing associated with block 370, a determination is made that known avatars should be marked, control proceeds to a “Mark Avatar” block 372.

During processing associated with block 372, the corresponding avatar in scene 182 displayed is conjunction with an appropriate symbol (see 188 and 192, FIG. 3). In addition, any number corresponding to a suggested order of contact may be added. It should also be noted that the marking of any particular avatar may necessitate the modification of the markings of other avatars, for example when the suggested order of contact needs adjustment. Once the selected avatar has been marked or, if during processing associated with 370, a determination is made that the known avatars are not marked, control proceeds to a “More Avatars?” block 374. During processing associate with block 374, a determination is made as to whether or not there are more avatars detected during processing associated with 358 that remain to be processed. If so, control returns to block 362, the next avatar is selected and processing continues as described above. If not, control proceeds to an “End Analyze Scene” block 379 during which process 350 is complete.

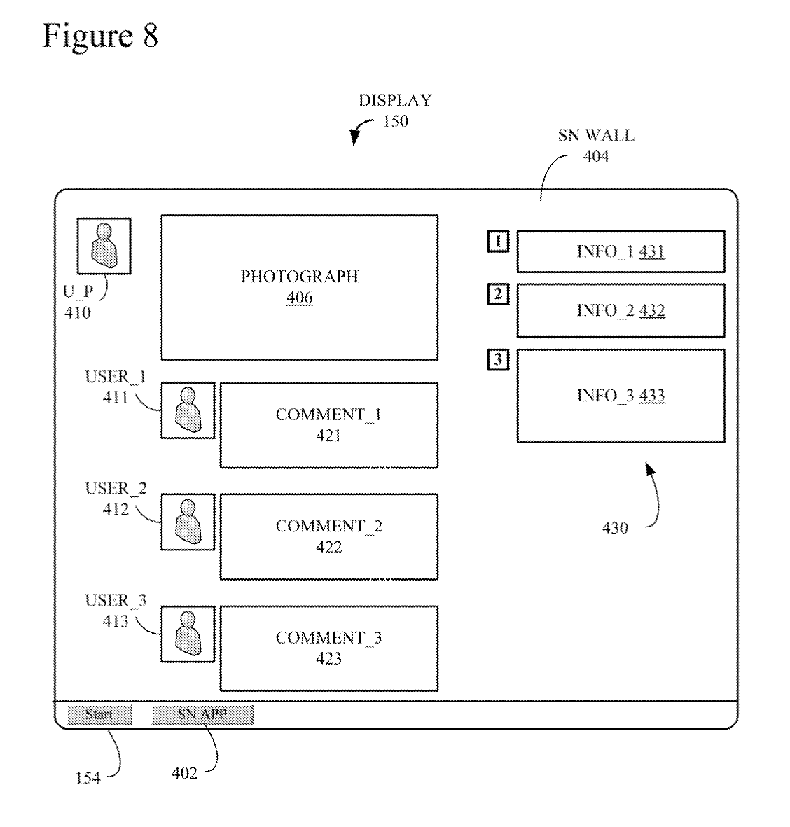

FIG. 8 is an illustration of display 150 (FIGS. 2 and 3) showing an example of a view in a social networking (SN) application that implements the claimed subject matter. The mechanics of the data collection, analysis and display would be similar to that described above in conjunction with FIGS. 2-7. FIG. 8 is provided to illustrate how the claimed subject matter may look with respect to a SN application or service. In addition, FIG. 8 illustrates a “list” type of display rather than a “marking” type.

Display 150 includes a Start button (FIGS. 2 and 3) and a menu bar icon 402 corresponding to an application rendering the SN application. In the this example, the SN application is displaying a “wall,” i.e. SN Wall 404, in which a photograph 406 has been placed, or “posted,” by a user, i.e. a user_prime, represented by a characterization U_P 410. Three additional users, represented by characterizations, i.e. a user_{—}1 411, a user_{—}2 412 and a user_{—}3 413, have posted comments corresponding to photograph 406, i.e. a comment_{—}1 412, a comment_{—}2 422 and a comment_{—}3 423, respectively.

In accordance with the claimed subject matter a list 430 of information relating to users associated with user characterizations 411-413 are also displayed, specifically an info_{—}1 431, an info_{—}2 432 and an info_{—}3 433. Information 431-432 may not directly correspond to user characterizations 411-413, respectively, but rather may correspond to an importance placed on different users by analysis engine 210 (FIG. 4). Particular information 431-433 may be associated with specific user characterizations 411-413 in different configurations. For example, particular information 431-433 may be highlighted when the corresponding user characterization 411-413 is clicked on or a cursor (not shown) is positioned over. Vice versa, particular user characterization 411-413 may be highlighted when the corresponding information 431-433 is clicked on or a cursor (not shown) is positioned over. It should also be understood that each user characterization 411-413 may not correspond to any of information 431-433.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method, comprising:
storing information for identifying and characterizing a plurality of user characterizations associated with a social networking application;
parsing a display associated with the social networking application to identify a first user characterization of the plurality of user characterizations;
correlating the first user characterization to a first portion of the stored information;
analyzing the first portion with respect to a first user-defined criteria; and
in response to a determination that the first portion satisfies the first user-defined criteria, displaying, on the display, first data corresponding to the first portion in conjunction with a first indicia to enable the first data to be associated with the first user characterization.

2. The method of claim 1, wherein the social networking application is a virtual world.

3. The method of claim 1, wherein the social network application is a social networking service.

4. The method of claim 1, further comprising generating a greeting, based upon the first portion of information, wherein the greeting is included in the first data.

5. The method of claim 1, further comprising:
parsing the display associated with the social networking application to identify a second user characterization of the plurality of user characterizations;
correlating the second user characterization to a second portion of the stored information;
analyzing the first portion with respect to the second portion to produce a correlation between the first user characterization and the second user characterization; and
displaying, on the display, second data corresponding to the correlation in conjunction with second indicia to enable the second data to be associated with the second user characterization.

6. The method of claim 5, further comprising displaying, in conjunction with each of the first and second data, a respective suggested order, the suggested order corresponding to a suggested order of contact with respect to the first and second user characterizations.

7. The method of claim 1, further comprising:
identifying a first instantiation of the first user characterization in the social networking application; and
in response to a prompt, gathering data corresponding to the user characterization and the first instantiation; and
storing the gathered data in conjunction with the stored information for identifying and characterizing the plurality of user characterizations associated with the social networking application.

8. The method of claim 7, wherein the gathered data is one or more of:
date of the first instantiation;
time of the first instantiation;
name of a user associated with the first user characterization;
an email address of the user; and
a graphic representation of the first user characterization.

9. The method of claim 1, wherein the first portion is analyzed based upon one or more of:
a history corresponding to a previous interaction between the first user characterization and a second user characterization;
a rating based upon the previous interaction;
a status corresponding to a user associated with the first user characterization;
a relationship between the user and a second user corresponding to a second user characterization; and
a proximity between the first user characterization and the second user characterization.

10. The method of claim 1, further comprising toggling the displaying on and off in response to a user-defined parameter.

11. The method of claim 1, wherein the displaying is in response to a cursor on the display positioned in proximity to the first user characterization.

12. An apparatus, comprising:
a processor;
a computer-readable storage medium (CRSM) coupled to the monitor; and
logic, stored on the CRSM and executed on the processor, for:
storing, on the CRSM, information for identifying and characterizing a plurality of user characterizations associated with a social networking application;
parsing a display associated with the social networking application to identify a first user characterization of the plurality of user characterizations;
correlating the first user characterization to a first portion of the stored information;
analyzing the first portion with respect to a first user-defined criteria; and
in response to a determination that the first portion satisfies the first user-defined criteria, displaying, on the display, first data corresponding to the first portion in conjunction with a first indicia to enable the first data to be associated with the first user characterization.

13. The apparatus of claim 12, the logic further comprising logic for:
parsing the display associated with the social networking application to identify a second user characterization of the plurality of user characterizations;
correlating the second user characterization to a second portion of the stored information;
analyzing the first portion with respect to the second portion to produce a correlation between the first user characterization and the second user characterization; and
displaying, on the display, second data corresponding to the correlation in conjunction with second indicia to enable the second data to be associated with the second user characterization.

14. The apparatus of claim 12, the logic further comprising logic for:
identifying a first instantiation of the first user characterization in the social networking application; and
in response to a prompt, gathering data corresponding to the user characterization and the first instantiation; and
storing the gathered data in conjunction with the stored information for identifying and characterizing the plurality of user characterizations associated with the social networking application.

15. The apparatus of claim 14, wherein the gathered data is one or more of date of the first instantiation;
time of the first instantiation;
name of a user associated with the first user characterization;
an email address of the user; and
a graphic representation of the first user characterization.

16. The apparatus of claim 12, wherein the first portion is analyzed based upon one or more of:
a history corresponding to a previous interaction between the first user characterization and a second user characterization;
a rating based upon the previous interaction;
a status corresponding to a user associated with the first user characterization;
a relationship between the user and a second user corresponding to a second user characterization; and
a proximity between the first user characterization and the second user characterization.

17. A computer programming product, comprising:
a computer-readable storage medium (CRSM); and
logic, stored on the CRSM for execution on a processor, for:
storing, on the CRSM, information for identifying and characterizing a plurality of user characterizations associated with a social networking application;
parsing a display associated with the social networking application to identify a first user characterization of the plurality of user characterizations;
correlating the first user characterization to a first portion of the stored information;
analyzing the first portion with respect to a first user-defined criteria; and
in response to a determination that the first portion satisfies the first user-defined criteria, displaying, on the display, first data corresponding to the first portion in conjunction with a first indicia to enable the first data to be associated with the first user characterization.

18. The computer programming product of claim 17, the logic further comprising logic for:
parsing the display associated with the social networking application to identify a second user characterization of the plurality of user characterizations;
correlating the second user characterization to a second portion of the stored information;
analyzing the first portion with respect to the second portion to produce a correlation between the first user characterization and the second user characterization; and
displaying, on the display, second data corresponding to the correlation in conjunction with second indicia to enable the second data to be associated with the second user characterization.

19. The computer programming product of claim 18, the logic further comprising logic for:
identifying a first instantiation of the first user characterization in the social networking application; and
in response to a prompt, gathering data corresponding to the user characterization and the first instantiation; and
storing the gathered data in conjunction with the stored information for identifying and characterizing the plurality of user characterizations associated with the social networking application.

20. The computer programming product of claim 19, wherein the gathered data is one or more of:
date of the first instantiation;
time of the first instantiation;
name of a user associated with the first user characterization;
an email address of the user; and
a graphic representation of the first user characterization.

21. The computer programming product of claim 18, wherein the first portion is analyzed based upon one or more of:
a history corresponding to a previous interaction between the first user characterization and a second user characterization;
a rating based upon the previous interaction;
a status corresponding to a user associated with the first user characterization;
a relationship between the user and a second user corresponding to a second user characterization; and
a proximity between the first user characterization and the second user characterization.

22. A device, comprising:
a processor;
a computer-readable storage medium (CRSM) coupled to the processor;
a monitor coupled to the processor; and
logic, stored on the CRSM and executed on the processor, for:
storing, on the CRSM, information for identifying and characterizing a plurality of user characterizations associated with a social networking application;
parsing a display rendered on the monitor associated with the social networking application to identify a first user characterization of the plurality of user characterizations;
correlating the first user characterization to a first portion of the stored information;
analyzing the first portion with respect to a first user-defined criteria; and
in response to a determination that the first portion satisfies the first user-defined criteria, displaying, on the display, first data corresponding to the first portion in conjunction with a first indicia to enable the first data to be associated with the first user characterization.

23. The device of claim 22, the logic further comprising logic for:
parsing the display associated with the social networking application to identify a second user characterization of the plurality of user characterizations;
correlating the second user characterization to a second portion of the stored information;
analyzing the first portion with respect to the second portion to produce a correlation between the first user characterization and the second user characterization; and
displaying, on the display, second data corresponding to the correlation in conjunction with second indicia to enable the second data to be associated with the second user characterization.

24. The device of claim 22, the logic further comprising logic for:
identifying a first instantiation of the first user characterization in the social networking application; and
in response to a prompt, gathering data corresponding to the user characterization and the first instantiation; and
storing the gathered data in conjunction with the stored information for identifying and characterizing the plurality of user characterizations associated with the social networking application.

25. The device of claim 24, wherein the gathered data is one or more of:
date of the first instantiation;
time of the first instantiation;
name of a user associated with the first user characterization;
an email address of the user; and
a graphic representation of the first user characterization; and
wherein the first portion is analyzed based upon one or more of:
a history corresponding to a previous interaction between the first user characterization and a second user characterization;
a rating based upon the previous interaction;
a status corresponding to a user associated with the first user characterization;
a relationship between the user and a second user corresponding to a second user characterization; and
a proximity between the first user characterization and the second user characterization.
